(19) United States
(12) Patent Application Publication
(10) Pub. No.: US 2006/0064847 A1
(43) Pub. Date: Mar. 30, 2006

(54) Decorative surface mounted hinges

(76) Inventor: Ernest Henry Konshuk, Spangle, WA (US)

Correspondence Address: ERNEST HENRY KONSHUK, 19420 So. Smythe Rd., Spangle, WA, 99031, US

(21) Appl. No.: 11/239,486

(22) Filed: Sep. 28, 2005

Related U.S. Application Data
(60) Provisional application No. 60/613,639, filed on Sep. 28, 2004.

(51) Int. Cl. E05D 7/10

(52) U.S. Cl. 16/263

(57) ABSTRACT

A decorative hinge does more—but also has shocking eye appeal. A hinge that can turn fish, whales, animal, birds and insects into designer hinges. The different designs and figures that can be made into hinges will never end. Especially adds sales appeal. Being a surface mounted hinge, that gives you a full opening—as a 28″ door will be 28″ wide instead of 26″ as now. That will allow room for wheel chair passage—that has never been possible. You do not have to reconstruct a home to apply a surface mounted hinge.

### CROSS-REFERENCES TO RELATED APPLICATIONS

This application claims the benefits Provisional Patent application Section 60/613,639 filed 2004 Sep. 28, as amended on 2004, Oct. 22.

Federally sponsored research not applicable.

Sequence listing or program not applicable.

### BACKGROUND OF INVENTION

1. Field of Invention

This invention relates to opening and closing of doors, windows, gates, signs, or objects that would require a hinge movement.

2. Prior Art

All doors, windows, and gates, most use hinges. Door hinges are usually concealed butt hinges, that only allow the door to swing as it also protrudes, making the access area smaller, by the thickness of the door. Surface mounted hinges, that can be offset allow more walk through area. Also wheel chair clearance.

You hardly see butt hinges or making them attractive is out. Surface mounted hinges that are eye catching, add beauty, plus sales appeal.

Objects and Advantages

A hinge is required in the operation of all doors, gates, some windows, and some signs that open, shut, or have some movement. They are easier to install, adding much mor beauty. The function is to open wider by offsetting the hinges.

### SUMMARY

The body of the hinge can be made from flat sheet steel. By cutting or stamping a punch press is normally used in production. The pin housing is also formed with use of a punch press—a machine built for this purpose. For smaller applications, you can machine cut this outline of the bodies. The pin section housing may be manually cut and then welded to the hinge body to form the pin body. The pin is made from round stock to fit the pin body.

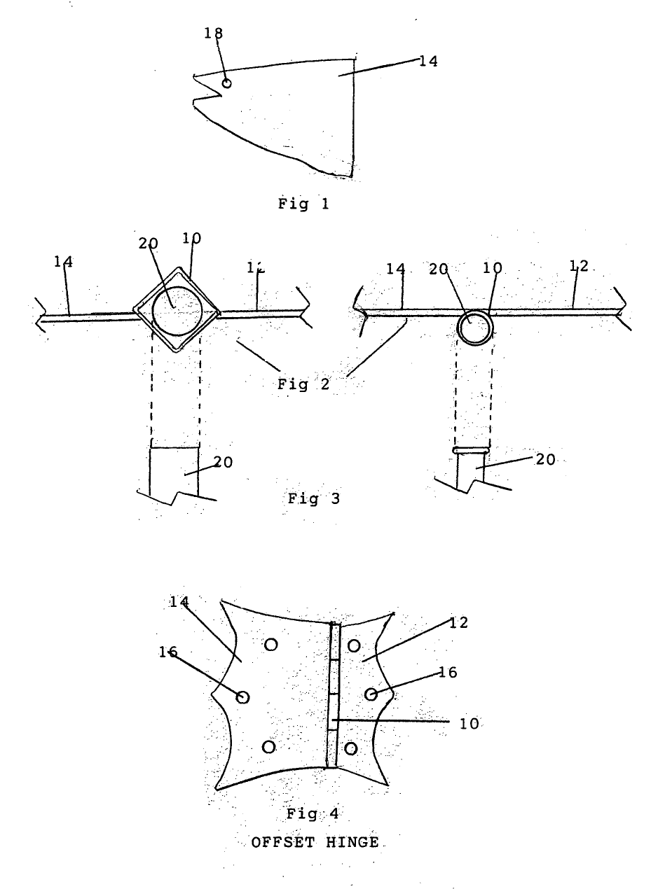

FIG. 1. Show the 1 section of the hinge design.

FIG. 2. Shows the pin housing square type and round type as formed by a punch press.

FIG. 3. Shows the pin.

FIG. 4. Show the hinges as it may be offset.

| | |
|---|---|
| 10 | pin housing |
| 12 | right body part |
| 14 | left body part |
| 16 | holes for mounting |
| 18 | hole for eye |
| 20 | pivot pin |

### DRAWINGS

There is almost no end to designs off these surface mounted hinges. All shown (page 3) of the front view by turning them over will reverse the image. Offset hinge exhibit A (page 3) may also be reversed for doors that swing either way.

### DETAILED DESCRIPTION PREFERRED EMBODIMENT

Hinges of steel construction usually cut or stamped, can also be torch cut, and machine formed, or punch press formed to hold a pin that two outer sections pivot on—giving it the hinge effect. The offset hinge may be made with one body being wider than the other so that it may be offset and still have the ability to be fastened to background material that will hold the screws. So sometimes #13 and #14 body parts will be wider.

Operation of Invention

Being a hinge only has one moving part as one half is normally secured.

### CONCLUSION, RAMIFICATIONS AND SCOPE

Hinges that bend or swing in the middle are hinges, but decorative hinges have sales appeal. Surface mounted hinges are applicable, as they may be offset, another invention.

Surface mounted hinges are much easier to install, does not require the education of a carpenter, or the working skill of countersinking, measuring, and chiseling.

1. Decorative, surface mounted hinges by Ernest H. Konshuk sole invention made up of two parts and a connecting pin. Lift body portion #14 the right body portion #12 the #20 pin that holds the two sections together. The on demand will pivot.
You have a hinge, say, mounted to a door by removing the #20 pin the door may be removed unless the pin is secured, welded or peened, for security measures.
DEPENDENT CLAIMS
A door could also be removed by removing the fasteners. By removing the screws unless a move retractable screw was used for protection against breaking and entering.
SECOND MAIN CLAIM
Decorative hinges, eye catching appeal to everyone from horse lovers to whale watchers. They may be painted, skip sanded, polished, lacquered, etched, plated, baked, heat treated, plus other finishes to add to the appeal. They not only look nice they are necessary. They can also be fastened by screws, bolts, welded, riveted, etc.
